(19) United States
(12) Patent Application Publication
(10) Pub. No.: US 2014/0152833 A1
(43) Pub. Date: Jun. 5, 2014

(54) CORRESPONDING AN IMAGE SUBJECT TO OTHER IMAGE ELEMENTS FOR GENERATING TARGETED INFORMATION

(71) Applicant: CHRONOTRACK SYSTEMS CORP., Evansville, IN (US)

(72) Inventors: Paul Itoi, Davis, CA (US); Tate Knutstad, San Diego, CA (US)

(73) Assignee: ChronoTrack Systems Corp., Evansville, IN (US)

(21) Appl. No.: 13/706,136

(22) Filed: Dec. 5, 2012

(51) Int. Cl. G06K 9/00; H04N 7/18

(52) U.S. Cl. CPC G06K 9/00288; H04N 7/18; G06Q 30/0269
USPC 348/157; 382/115; 382/118

(57) ABSTRACT

Targeted information is generated for a participant in an activity. An image or video depicting the participant is received and the participant is identified in the image or video from a participant profile electronically stored in a database of participant information. The participant profile includes identifying information about the participant and contact information for the participant. The database of participant information includes participant profiles for a plurality of participants in the activity. One or more product identifying indicia associated with the participant are identified in the image or video, and a package of targeted information is generated based on the identifying information in the participant profile and the identified one or more product identifying indicia. The package of targeted information is provided to the participant using the contact information from the participant profile.

### TECHNICAL FIELD

The present disclosure relates generally to computer systems configured to generate targeted information. More specifically, the present disclosure relates to computer systems configured to correspond an image subject to other image elements for generating targeted information directed to the image subject.

### BACKGROUND

Athletic events, such as running races, have become increasingly popular as emphasis has been placed on the benefits of living a healthy and active lifestyle. The participants in the athletic events are timed to allow the participants to compare their performance with personal goals, as well as gauge performance improvements with respect to earlier similar athletic events. The participants can wear an electronic device, such as a transponder, that communicates with receivers along route of the athletic event to establish the participant's time at various checkpoints along the route.

In some athletic events, event organizers or companies associated with the event position still image and/or video cameras along the route to photograph or record the participant during the athletic event. The images or videos captured by the cameras may then be made available for browsing by the participants, such as on a website associated with the athletic event. The website may allow the participants to search through the images or videos by entering a bib number or other identifying indicium to view images or videos associated with a particular participant. The participants may also have the option to purchase the images or videos for a fee.

### SUMMARY

In one aspect, the present disclosure relates to a method for generating targeted information for a participant in an activity. The method includes receiving an image or video depicting the participant and identifying the participant in the image or video from a participant profile electronically stored in a database of participant information. The participant profile includes identifying information about the participant and contact information for the participant. The database of participant information includes participant profiles for a plurality of participants in the activity. The method also includes identifying one or more product identifying indicia associated with the participant in the image or video, and generating a package of targeted information based on the identifying information in the participant profile and the identified one or more product identifying indicia. The method further includes providing the package of targeted information to the participant using the contact information from the participant profile.

In another aspect, the present disclosure relates to a method for generating targeted information for a participant in an athletic event. The method includes images or videos of a plurality of participants in the athletic event, identifying the participant in at least one of the images or videos, and correlating the at least one of the images or videos to a participant profile electronically stored in a database of participant information. The participant profile includes identifying information about the participant, and the database of participant information includes participant profiles for the plurality of participants in the athletic event. The method also includes identifying one or more product identifying indicia associated with the participant in the at least one image or video, and correlating the one or more product identifying indicia to the participant profile. The method further includes generating a package of targeted information based on the identifying information in the participant profile and the identified one or more product identifying indicia, and providing the package of targeted information to the participant.

In a further aspect, the present disclosure relates to a system configured to generate targeted information for a participant in an athletic event. One or more cameras are arranged to capture images or videos of a plurality of participants in the athletic event. A plurality of electronic devices, each associated with one of the plurality of participants, is configured to transmit electronic information. An electronic database of participant information includes participant profiles for the plurality of participants in the athletic event. A marketing computer is associated with the one or more cameras, plurality of electronic devices, and the electronic database. The marketing computer is configured to (a) identify the participant in at least one of the images or videos captured by the one or more cameras, (b) correlate the at least one of the images or videos to a participant profile of the participant stored in the electronic database of participant information, the participant profile including identifying information about the participant, (c) identify one or more product identifying indicia associated with the participant in the at least one image or video, (d) correlate the one or more product identifying indicia to the participant profile, (e) generate a package of targeted information based on the identifying information in the participant profile, the identified one or more product identifying indicia, and (f) the electronic information from the electronic device associated with the participant, and provide the package of targeted information to the participant.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system configured to associate a participant in an athletic event with product identifying indicia associated with the participant.

FIG. 2 is a flow diagram illustrating an embodiment of a process for associating a participant in an athletic event with product identifying indicia.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

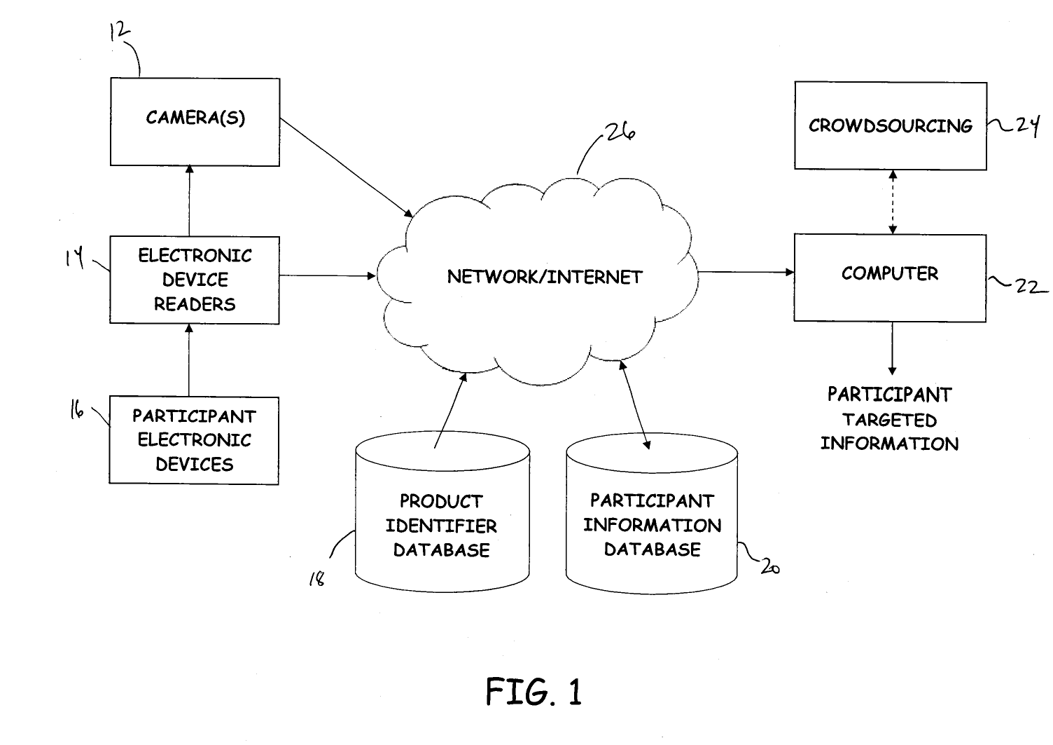

FIG. 1 is a block diagram of an embodiment of a system 10 configured to associate a participant in an athletic activity with product identifying indicia associated with the participant. The system 10 includes one or more cameras 12, one or more electronic device readers 14, participant electronic devices 16, a product identifier database 18, a participant information database 20, and a computer 22. In some embodiments, the computer 22 communicates with a crowdsourcing service 24. The cameras 12, electronic devices 14, product identifier database 18, and participant information database 20 are connected to the computer 22 via a network 26. The network 26 connects the components of the system 10, for example, via a local area network, wide area network, and/or the Internet.

The cameras 12 may be still image cameras, video cameras, or combinations thereof. The cameras 12 are positioned in relation to the athletic activity to capture still images and/or video of participants during the athletic activity. For example, if the athletic activity is a running race, the cameras 12 may be disposed at various points along the race course and operable to capture images and/or video of the participants as they pass by the cameras 12. The cameras 12 may be automatically operable in response to triggering input (e.g., a signal from an electronic device 16, as described below), may be remotely operated, or may be locally operated by a photographer. The cameras 12 are configured to provide the images and/or video captured to the computer 22 via the network 26. In alternative embodiments, the cameras 12 couple locally to a computer at the site of the athletic activity, which then forwards the images and/or video to the computer 22 via the network 26.

The electronic device readers 14 are configured to communicate with the participant electronic devices 16. The participant electronic devices 16 are coupled to the participants' clothing or other elements attached to the participants (e.g., a race bib) and provide information to the electronic device readers 14 when the participant is in proximity to the electronic device readers 14. In some embodiments, the participant electronic devices 16 are transponders that provide information to an electronic device reader 14 when interrogated by the electronic device reader 14. For example, in a race, the electronic device readers 14 may be disposed at checkpoints along the race route (e.g, periodic mile/kilometer markers). Each electronic device reader 14 may be configured to interrogate a participant's associated electronic device 16 to retrieve identification information (e.g., the participant's bib number, name, etc.) from the electronic device 16 as the participant passes the electronic device reader 14. In some embodiments, each participant electronic device 16 includes a radio frequency identification (RFID) tag, and each electronic device reader 14 comprises an RFID tag reader. One example system of electronic device readers 14 and participant electronic devices 16 is described in U.S. Pat. No. 8,174,393, entitled “RFID Tag Assembly and Method of Managing a Race,” which is incorporated by reference in its entirety for all purposes. The electronic device readers 14 are connected to the computer 22 via the network 26 such that the electronic device readers 14 can communicate information collected from the participants' electronic devices 16 to the computer 22. In some embodiments, the electronic device readers 14 communicate information collected from the participants' electronic devices 16 to a computer local to the athletic event, which then communicates the information to the computer 22 via the network 26.

In some embodiments, the electronic device readers 14 are in communication with the cameras 12 along the course such that, when a participant's electronic device 16 is sensed and read by an electronic device reader 14, one or more of the cameras 12 in proximity to the active electronic device reader 14 captures images and/or video of the participant. For example, in a running race, if the participant's electronic device 16 is secured to the participant's shoe, and the electronic device reader 14 is embedded in a mat along the race course, nearby cameras 12 can be configured to capture one or more images and/or videos of the participant as the participant runs over the mat. The information from the participant's electronic device 16 can then be linked to the one or more images and/or videos captured when sent to the computer 22 via the network 26. Example systems that correlate a participant's captured image with information from the participant's associated electronic device 16 are described in U.S. Pat. No. 7,158,689, entitled “Correlating Captured Images and Timed Event Data,” and U.S. Patent App. Pub. No. 2009/0141138, entitled “System and Methods for Capturing Images of an Event,” each of which is incorporated by reference in its entirety for all purposes.

The product identifier database 18 electronically stores information related to products and identifying features or marks associated with the products. In some embodiments, the product identifier database 18 stores logos, slogans, names, and other identifying indicia associated with a brand or product. For example, for an athletic event, the product identifier database 18 may store identifying indicia for brands associated with athletic wear (e.g., Nike®, Reebok®, ASICS®, Adidas®, etc.) that participants may be wearing during the race. In other contexts, such as in a consumer or user environment, the product identifier database 18 may also store brands and logos associated with products used in the environment.

The participant information database 20 electronically stores information about participants in the athletic event. For example, when a participant registers for an event, the participant may provide various personal information, including registration information such as name, address, telephone number, email address, social media usernames, etc., demographic information such as age, and other information about the participant, such as clothing size, ability level, etc. The information provided by the participant is stored as a participant profile in the participant information database. The participant profile may be created when the participant registers for the athletic activity. The participant profile can also include information related to the participant's electronic device 16. For example, the participant may register the electronic device 16 on the day of the athletic activity to associate the participant's profile with the electronic device 16. If the participant has participated in previous athletic activities, a participant profile for the participant may be already stored in the participant information database 20. As such, the participant profile may additionally include participant results from other athletic events, images or videos from other athletic events, as well as product identifying indicia worn by the participant in other athletic events. The participant information database 20 is configured to store participant profiles for each of the participants in new and previous athletic events.

The computer 22 receives information from the cameras 12, electronic device readers 14, product identifier database 18, and participant information database 20 via the network 26. The computer 22 is configured to process the information from the components of system 10 to generate targeted information for each participant in the athletic activity.

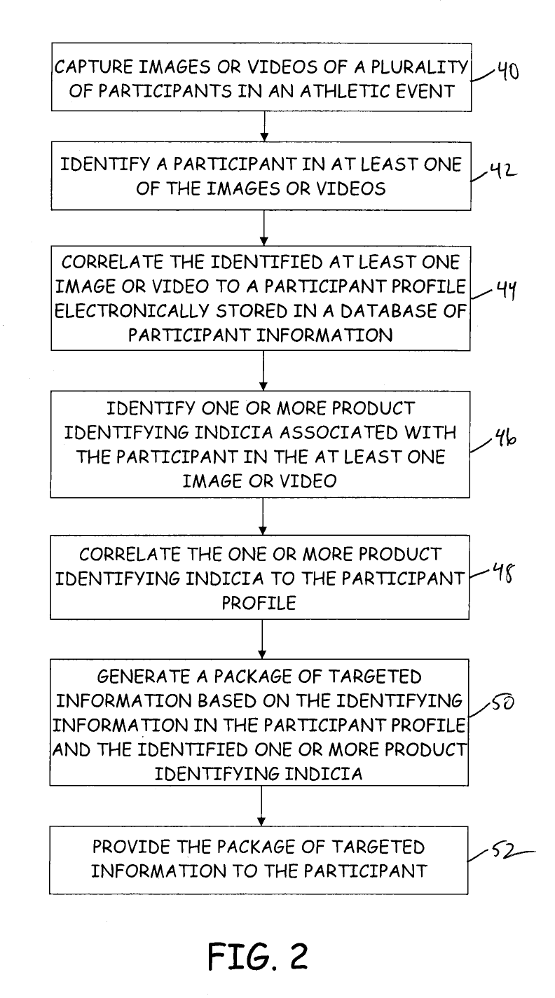

FIG. 2 is a flow diagram illustrating an embodiment of a process for associating a participant in an athletic event with product identifying indicia. In step 40, the cameras 12 capture images and/or videos of participants in the activity as described above. Then, in step 42, a participant is identified in at least one of the images or videos. In some embodiments, the computer 22 is configured with a facial recognition algorithm (e.g., software) that identifies the face of the participant in the at least one image or video and compares the identified face to previously captured and identified images or videos associated with participant profiles and stored in the participant information database 20. The previously captured and identified images or videos may be from prior athletic activities, or may have been supplied by the participants upon registration. The computer 22 may take various approaches to associating each participant's image or video with the participant's identification. For example, methods and algorithms that may be incorporated into the system 10 are described, for example, in U.S. Pat. No. 6,545,705, entitled “Camera with Object Recognition Data Output,” which is incorporated by reference in its entirety for all purposes. In some embodiments, information from the facial recognition software output (e.g., the recognized face) is stored in the participant information database 20.

In some embodiments, the images and/or videos captured at the athletic activity are supplied by the computer 22 to a crowdsourcing service to identify participants in the images and/or videos. The crowdsourcing service can supply the images and/or videos, as well as previously captured and identified images and/or videos for comparison, to the crowdsourcing service. The crowdsourcing service then provides information back to the computer 22 including the images and/or videos with the participants therein identified. Example systems including crowdsourcing or outsourcing to perform tasks are described in U.S. Patent App. Pub. No. 2008/0208849, entitled “Methods for Identifying Audio or Video Content,” and U.S. Patent App. Pub. No. 2012/0072253, entitled “Outsourcing Tasks Via a Network,” each of which is incorporated by reference in its entirety for all purposes.

As another example, in embodiments in which participant's electronic device 16 triggers or is otherwise associated with the cameras 12, the linked information from the participant's electronic device 16 and the captured images and/or videos can be used to identify the participant. Further, in cases in which multiple participants appear in an image or video, a combination of information from electronic devices 16 of participants in the image or video and the facial recognition or crowdsourcing approaches described above can be used to identify each of the participants in the image and/or video.

In step 44, the images and/or videos in which the participant is identified is correlated to the participant's profile in the participant information database 20. For example, the images and/or videos in which the participant has been identified may be stored with or otherwise linked to the participant's profile in the participant information database 20. The images and/or videos associated with the participant's profile may then be used to identify the participant in future athletic activities using the facial recognition and/or crowdsourcing methods described above.

In step 46, one or more product identifying indicia associated with the participant in the images and/or video are identified. For example, the participant may be wearing a shirt, pants, shorts, hat, and/or shoes that bear a brand name, logo, slogan, or other product identifying indicia associated with a company. To identify the one or more product identifying indicia, the computer 22 can include an algorithm implemented in software that identifies product identifying indicia in an image or video and compares the identified product identifying indicia with information stored in the product identifier database 18. As another example, the crowdsourcing service 24 may be tasked with not only identifying participants in images and/or videos, but also identifying product identifying indicia associated with each of the participants.

In step 48, the computer 22 can then correlate the one or more product identifying indicia associated with the indicia to the participant's profile in the participant information database 20. For example, the one or more product identifying indicia associated with the participant can be electronically stored with other information about the participant in the participant's profile. The participant's profile can also include product identifying indicia from previous athletic activities.

The product identifying indicia and demographic information stored in the participant information database 20 can also be provided to companies or other organizations interested in correlating products with demographics to assist with future marketing efforts by the companies and organizations. Alternatively, companies and organizations can each maintain their own participant information database to assess the consumption of their own products and the products of the competition within a given demographic.

In step 50, the computer 22 can then generate a package of targeted information can then be generated based on the identifying information in the participant's profile and the one or more product identifying indicia associated with the participant's profile. The package of targeted information may take various forms, including, but not limited to, an email, an attachment to an email, a link to a webpage, contact via social media, and/or a mailing or physical package. For example, the package of targeted information can include the images and/or videos from the athletic activity correlated to the participant's profile, the participant's results from the athletic activity (e.g., race time), as well as advertisements, brochures, coupons, or products from the company or organization associated with the one or more product identifying indicia correlated with the participant's profile. The package can give the participant instructions on how to purchase the images and/or videos from the athletic activity.

In some embodiments, the package of targeted information may also be generated based on the participant's performance in the athletic activity. For example, information from the participant's electronic device 16 (e.g., race time, split times, etc.) may be used to characterize the participant's ability level in the athletic activity. The package of targeted information may then be tailored to the participant's ability level. For example, if the participant demonstrates a high performance level (e.g., marathon run with a sub-six minute average), the participant's targeted information may include elements that may be of higher interest to the participant, such as advertisements, coupons, and brochures related to high performance athletic wear and organizations geared toward people with high ability levels in the athletic activity. As another example, if the participant demonstrates an average performance level (e.g., marathon with a 7-10 minute average), the participant's targeted information may include elements that are geared toward people with a recreational level or interest in the athletic activity.

After the package of targeted information is generated, then, instep 52, the computer 22 provides the package of targeted information to the participant. The computer 22 may send the package of targeted information to the participant based on the contact information associated with the participant's profile in the participant information database 20.

While the system 10 has been described in the context of athletic activities, such as a running race, the system 10 can be configured to generate targeted information for participants in other types of activities as well. For example, the system 10 can be configured to associate product identifiers with identified individuals in consumer environments, such as retail stores and grocery stores. Additionally, the system 10 can be configured to associate product identifiers with individuals in other types of activities, such as sporting events and music concerts.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A method for generating targeted information for a participant in an activity, the method comprising:
receiving an image or video depicting the participant;
identifying the participant in the image or video from a participant profile electronically stored in a database of participant information, wherein the participant profile includes identifying information about the participant and contact information for the participant, and wherein the database of participant information includes participant profiles for a plurality of participants in the activity;
identifying one or more product identifying indicia associated with the participant in the image or video;
generating a package of targeted information based on the identifying information in the participant profile and the identified one or more product identifying indicia; and
providing the package of targeted information to the participant using the contact information from the participant profile.

2. The method of claim 1, wherein identifying the participant in the image or video comprises:
receiving electronic information from an electronic device associated with the participant when the received image or video is captured; and
retrieving the participant profile from the database of participant information based on the electronic identification information.

3. The method of claim 2, wherein the electronic device comprises a radio frequency identification (RFID) tag.

4. The method of claim 2, wherein activity is a race, and wherein the electronic identification information includes a participant race time when the received image or video is captured.

5. The method of claim 4, wherein the targeted information comprises information directed to an ability level of the participant based on the participant race time.

6. The method of claim 1, wherein activity is a race, and wherein identifying the participant in the image or video comprises matching a race bib number associated with the participant in the image or video with a bib number associated with the participant profile.

7. The method of claim 1, wherein identifying one or more product identifying indicia comprises:
identifying a logo or brand name on clothing worn by the participant.

8. The method of claim 1, wherein the step of identifying the participant comprises:
providing the image or video to a crowdsourcing service to identify the participant.

9. The method of claim 1, wherein the database of participant information stores images of the plurality of participants in association with the participant profiles for the plurality of participants, and the step of identifying the participant comprises:
performing a computer-implemented face recognition comparison on a face portion of the participant in the image or video to face portions in the stored images of the plurality of participants.

10. The method of claim 1, wherein the identifying information in the participant profile comprises the participant's name, age, and clothing size.

11. A method for generating targeted information for a participant in an athletic event, the method comprising:
capturing images or videos of a plurality of participants in the athletic event;
identifying the participant in at least one of the images or videos;
correlating the identified at least one of the images or videos to a participant profile electronically stored in a database of participant information, wherein the participant profile includes identifying information about the participant, and wherein the database of participant information includes participant profiles for the plurality of participants in the athletic event;
identifying one or more product identifying indicia associated with the participant in the at least one image or video;
correlating the one or more product identifying indicia to the participant profile;
generating a package of targeted information based on the identifying information in the participant profile and the identified one or more product identifying indicia; and
providing the package of targeted information to the participant.

12. The method of claim 11, wherein identifying the participant in the image or video comprises:
receiving electronic identification information from an electronic device associated with the participant when the received image or video is captured.

13. The method of claim 12, wherein the electronic identification information includes a participant race time when the received image or video is captured.

14. The method of claim 13, wherein the targeted information comprises information directed to an ability level of the participant based on the participant race time.

15. The method of claim 11, wherein identifying the participant in the image or video comprises matching a race bib number associated with the participant in the image or video with a bib number associated with the participant profile.

16. The method of claim 11, wherein identifying one or more product identifying indicia comprises:
identifying a logo or brand name on clothing worn by the participant.

17. The method of claim 12, wherein the step of identifying the participant comprises:
providing the image or video to a crowdsourcing service to identify the participant.

18. The method of claim 11, wherein the database of participant information stores images of the plurality of participants in association with the participant profiles for the plurality of participants, and the step of identifying the participant comprises:
performing a computer-implemented face recognition comparison on a face portion of the participant in the image or video to face portions in the stored images of the plurality of participants.

19. The method of claim 11, wherein the identifying information in the participant profile comprises the participant's name, age, and clothing size.

20. A system configured to generate targeted information for a participant in an athletic event, the system comprising:
one or more cameras arranged to capture images or videos of a plurality of participants in the athletic event;
a plurality of electronic devices each associated with one of the plurality of participants, the electronic devices configured to transmit electronic information;
an electronic database of participant information including participant profiles for the plurality of participants in the athletic event;
a marketing computer associated with the one or more cameras, plurality of electronic devices, and the electronic database, the marketing computer configured to
identify the participant in at least one of the images or videos captured by the one or more cameras,
correlate the at least one of the images or videos to a participant profile of the participant stored in the electronic database of participant information, the participant profile including identifying information about the participant,
identify one or more product identifying indicia associated with the participant in the at least one image or video,
correlate the one or more product identifying indicia to the participant profile,
generate a package of targeted information based on the identifying information in the participant profile, the identified one or more product identifying indicia, and the electronic information from the electronic device associated with the participant, and
provide the package of targeted information to the participant.
